(19) United States
(12) Patent Application Publication
(10) Pub. No.: US 2026/0361358 A1
(43) Pub. Date: Nov. 12, 2026

(54) UPLINK SYNCHRONIZATION WITH LOWER POWER WAKE-UP SIGNALS

(71) Applicant: Nokia Technologies Oy, Espoo (FI)

(72) Inventors: Chunli WU, Beijing (CN); Samuli Heikki TURTINEN, Ii (FI); Jussi-Pekka KOSKINEN, Oulu (FI); Jorma Johannes KAIKKONEN, Oulu (FI)

(21) Appl. No.: 19/125,789

(22) PCT Filed: Nov. 7, 2022
(86) PCT No.: PCT/CN2022/130442

§ 371 Date: Apr. 30, 2025

(51) Int. Cl. H04B 7/06; H04L 5/00; H04W 52/02

(52) U.S. Cl. CPC H04B 7/0626; H04L 5/0044; H04W 52/0235

(57) ABSTRACT

Example embodiments of the present disclosure relate to UL-synchronization in LP-WUS receiving mode. In an example method, an apparatus receives, from a network device, configuration information related to at least one of a channel-state information (CSI) report or a sounding reference signal (SRS) in a low power wake-up signal (LP-WUS) receiving mode of the apparatus. The apparatus performs one of the following based on the configuration information: transmitting, to the network device and while the apparatus is in the LP-WUS receiving mode, the at least one of the CSI report or the SRS, or stopping transmission of the at least one of the CSI report or the SRS when the apparatus is in the LP-WUS receiving mode. In this way, UL-synchronization can be kept when the apparatus is in LP-WUS receiving mode.

### FIELD

Example embodiments of the present disclosure generally relate to the field of telecommunication, and in particular, to apparatuses, methods and a computer-readable storage medium for uplink (UL) synchronization with low power wake-up signal (LP-WUS).

### BACKGROUND

5G systems are designed and developed targeting for both mobile telephony and vertical use cases. Besides latency, reliability, and availability, UE energy efficiency is also critical to 5G. Currently, 5G devices may have to be recharged per week or day, depending on individual's usage time. In general, 5G devices consume tens of milliwatts in RRC idle/inactive state and hundreds of milliwatts in RRC connected state. Designs to prolong battery life is a necessity for improving energy efficiency as well as for better user experience.

### SUMMARY

In general, example embodiments of the present disclosure provide a solution for UL synchronization with LP-WUS for UE.

In a first aspect, there is provided an apparatus. The apparatus comprises: at least one processor; and at least one memory storing instructions that, when executed by the at least one processor, cause the apparatus at least to: receive, from a network device, configuration information related to at least one of a channel-state information (CSI) report or a sounding reference signal (SRS) in a low power wake-up signal (LP-WUS) receiving mode of the apparatus; and perform one of the following based on the configuration information: transmitting, to the network device and while the apparatus is in the LP-WUS receiving mode, the at least one of the CSI report or the SRS, or stopping transmission of the at least one of the CSI report or the SRS when the apparatus is in the LP-WUS receiving mode.

In a second aspect, there is provided an apparatus. The apparatus comprises: at least one processor; and at least one memory storing instructions that, when executed by the at least one processor, cause the apparatus at least to: determine configuration information of at least one of a channel-state information (CSI) report or a sounding reference signal (SRS) in a low power wake-up signal (LP-WUS) receiving mode of a terminal device; and transmit, to the terminal device, the configuration information.

In a third aspect, there is provided a method performed by a terminal device. The method comprises: receiving, at the terminal device and from a network device, configuration information related to at least one of a channel-state information (CSI) report or a sounding reference signal (SRS) in a low power wake-up signal (LP-WUS) receiving mode of the terminal device; and performing one of the following based on the configuration information: transmitting, by the terminal device, to the network device and while the terminal device is in the LP-WUS receiving mode, the at least one of the CSI report or the SRS, or stopping, by the terminal device, transmission of the at least one of the CSI report or the SRS when the apparatus is in the LP-WUS receiving mode.

In a fourth aspect, there is provided a method performed by a network device. The method comprises: determining, by the network device, configuration information of at least one of a channel-state information (CSI) report or a sounding reference signal (SRS) in a low power wake-up signal (LP-WUS) receiving mode of a terminal device; and transmitting by the network device and to the terminal device, the configuration information.

In a fifth aspect, there is provided an apparatus. The apparatus comprises: means for receiving, from a network device, configuration information related to at least one of a channel-state information (CSI) report or a sounding reference signal (SRS) in a low power wake-up signal (LP-WUS) receiving mode of the apparatus; and means for performing one of the following based on the configuration information: transmitting, to the network device and while the apparatus is in the LP-WUS receiving mode, the at least one of the CSI report or the SRS, or stopping transmission of the at least one of the CSI report or the SRS when the apparatus is in the LP-WUS receiving mode.

In a sixth aspect, there is provided an apparatus. The apparatus comprises: means for determining configuration information of at least one of a channel state information (CSI) report or a sounding reference signal (SRS) in a low power wake-up signal (LP-WUS) receiving mode of a terminal device; and means for transmitting, to the terminal device, the configuration information.

In a seventh aspect, there is provided a non-transitory computer-readable storage medium having instructions stored thereon. The instructions, when executed by an apparatus, cause the apparatus to perform at least the following: receiving, from a network device, configuration information related to at least one of a channel-state information (CSI) report or a sounding reference signal (SRS) in a low power wake-up signal (LP-WUS) receiving mode of the apparatus; and performing one of the following based on the configuration information: transmitting, to the network device and while the apparatus is in the LP-WUS receiving mode, the at least one of the CSI report or the SRS, or stopping transmission of the at least one of the CSI report or the SRS when the apparatus is in the LP-WUS receiving mode.

In an eighth aspect, there is provided a non-transitory computer-readable storage medium having instructions stored thereon. The instructions, when executed by an apparatus, cause the apparatus to perform at least the following: determining configuration information of at least one of a channel-state information (CSI) report or a sounding reference signal (SRS) in a low power wake-up signal (LP-WUS) receiving mode of a terminal device; and transmitting, to the terminal device, the configuration information.

In a ninth aspect, there is provided a computer program comprising instructions, which, when executed by an apparatus, cause the apparatus at least to: receive, from a network device, configuration information related to at least one of a channel-state information (CSI) report or a sounding reference signal (SRS) in a low power wake-up signal (LP-WUS) receiving mode of the apparatus; and perform one of the following based on the configuration information: transmitting, to the network device and while the apparatus is in the LP-WUS receiving mode, the at least one of the CSI report or the SRS, or stopping transmission of the at least one of the CSI report or the SRS when the apparatus is in the LP-WUS receiving mode.

In a tenth aspect, there is provided a computer program comprising instructions, which, when executed by an apparatus, cause the apparatus at least to: determine configuration information of at least one of a channel-state information (CSI) report or a sounding reference signal (SRS) in a low power wake-up signal (LP-WUS) receiving mode of a terminal device; and transmit, to the terminal device, the configuration information.

In an eleventh aspect, there is provided an apparatus. The apparatus comprises: receiving circuitry configured to receive, from a network device, configuration information related to at least one of a channel-state information (CSI) report or a sounding reference signal (SRS) in a low power wake-up signal (LP-WUS) receiving mode of the apparatus; and performing circuitry configured to perform one of the following based on the configuration information: transmitting, to the network device and while the apparatus is in the LP-WUS receiving mode, the at least one of the CSI report or the SRS, or stopping transmission of the at least one of the CSI report or the SRS when the apparatus is in the LP-WUS receiving mode.

In a twelfth aspect, there is provided an apparatus. The apparatus comprises: determining circuitry configured to determine configuration information of at least one of a channel-state information (CSI) report or a sounding reference signal (SRS) in a low power wake-up signal (LP-WUS) receiving mode of a terminal device; and transmitting circuitry configured to transmit, to the terminal device, the configuration information.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1A illustrates an example of a network environment in which some example embodiments of the present disclosure may be implemented;

FIG. 1B illustrates a schematic diagram of UE operations with low-power wake-up receiver (WUR) based on which some example embodiments of the present disclosure may be implemented;

FIG. 2 illustrates a flowchart illustrating a communication process in accordance with some example embodiments of the present disclosure;

FIG. 3 illustrates an example of a process flow for CSI/SRS reporting in LP-WUS monitoring mode in accordance with some example embodiments of the present disclosure;

FIG. 4 illustrates an example of a process flow for stopping CSI/SRS reporting in LP-WUS monitoring mode in accordance with some example embodiments of the present disclosure;

FIG. 5 illustrates a flowchart of an example method implemented at a first device in accordance with some embodiments of the present disclosure;

FIG. 6 illustrates another flowchart of an example method implemented at a second device in accordance with some embodiments of the present disclosure;

FIG. 7 illustrates a simplified block diagram of a device that is suitable for implementing some example embodiments of the present disclosure; and

FIG. 8 illustrates a block diagram of an example of a computer-readable medium in accordance with some example embodiments of the present disclosure.

Throughout the drawings, the same or similar reference numerals represent the same or similar elements.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (for example, firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (for example, remote surgery), an industrial device and applications (for example, a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

Energy efficiency is even more critical for UE without a continuous energy source, e.g., UE using small rechargeable and single coin cell batteries. The power consumption depends on the configured length of wake-up periods, e.g., paging cycle. To meet the battery life requirements above, eDRX cycle with large value is expected to be used, resulting in high latency, which is not suitable for such services with requirements of both long battery life and low latency.

Currently, a UE architecture is proposed by using a wake-up signal to trigger the main radio and a separate receiver which has the ability to monitor wake-up signal with ultra-low power consumption. Main radio works for data transmission and reception, which can be turned off or set to deep sleep unless it is turned on. Basically, the NW triggers the UE to wake-up exactly when needed in an event-driven manner, by transmitting a special WUS to the UE, which is monitored by the dedicated LP-WUS receiver at the UE. When a UE receives the WUS, the WUS receiver can trigger the wake-up of the ordinary NR transceiver and communication can start. Thus, the ultra-low power receiver wakes up the main radio and otherwise, the main radio is OFF or kept in a deep sleep mode. The assumption is that the low-power wake-up receiver can be operated in an always ‘on’ manner with very low power consumption.

The intention is that the main radio of the UE can be in a sleep mode (or even powered off) for power saving and be activated only upon the reception of the wake-up signal from the network. Basically, the network triggers the UE to wake-up exactly when needed in an event-driven manner, by transmitting a special WUS to the UE, which is monitored by the dedicated low-power WUS receiver at the UE. When a UE receives the WUS, the WUS receiver can trigger the wake-up of the ordinary NR transceiver and communication can start. Thus, the ultra-low power receiver wakes up the main radio and otherwise, the main radio is OFF or kept in a deep sleep mode. The assumption is that the low-power wake-up receiver can be operated in an always ‘on’ manner with very low power consumption. In fact, it is expected that it will consume significantly less power compared to the NR transceiver, by designing a simple (WUS) signal and the use of dedicated hardware for its monitoring, which is only able to receive the WUS.

However, there is no discussion on whether it has impact on UL transmissions. Even if there is no data transmission when the UE is monitoring LP-WUS, it could still be desired to keep the UE UL in-sync to avoid long delay when there is data arrival as otherwise random access might be needed to synchronize the UL again. UL transmission would be needed for the NW to estimate UL timing and, accordingly, NW could provide TAC (Timing Advance Command) MAC CE before TAT expires. Thus, it needs to be discussed how UL transmission works when the UE is only monitoring LP-WUS.

In addition, in legacy schemes with DRX, the UE can be configured with periodic channel state information (CSI) reporting and Sounding Reference Signal (SRS) transmission during active time which can be used for UL-sync purpose as well as for proper NW scheduling when there is UL/DL data to be transmitted. If LP-WUS works without DRX, new mechanism needs to be defined for UL transmission. Besides, even if LP-WUS works on top of DRX, it is not power efficient to assume same periodicity of UL transmission for UL-sync purpose and for scheduling purpose.

Example embodiments of this disclosure relate to CSI and SRS related procedures in RRC CONNECTED mode, when UE is also configured with LP-WUS monitoring. However, this is a non-limiting example and similar embodiments may be applied by a UE in RRC_IDLE or RRC_INACTIVE mode, or in RRC CONNECTED mode when DRX is configured. Example embodiments of the present disclosure provide a mechanism to solve the above discussed issues. In some example embodiments of the present disclosure, different periodicity for CSI reporting and/or SRS transmission can be applied when the UE is monitoring only Low Power-WUS (called as LP-WUS monitoring mode hereafter; which can also be called as “LP-WUS receiving mode” in the disclosure) and after the UE is waken up by WUS. Since there is no data scheduling when the UE is monitoring only LP-WUS, SRS/CSI reporting periodicity for UL synchronization could be much longer than the one for data scheduling when the main receiver is on. In this way, UL-synchronization can be kept when the UE is in LP-WUS monitoring mode without increasing too much power consumption.

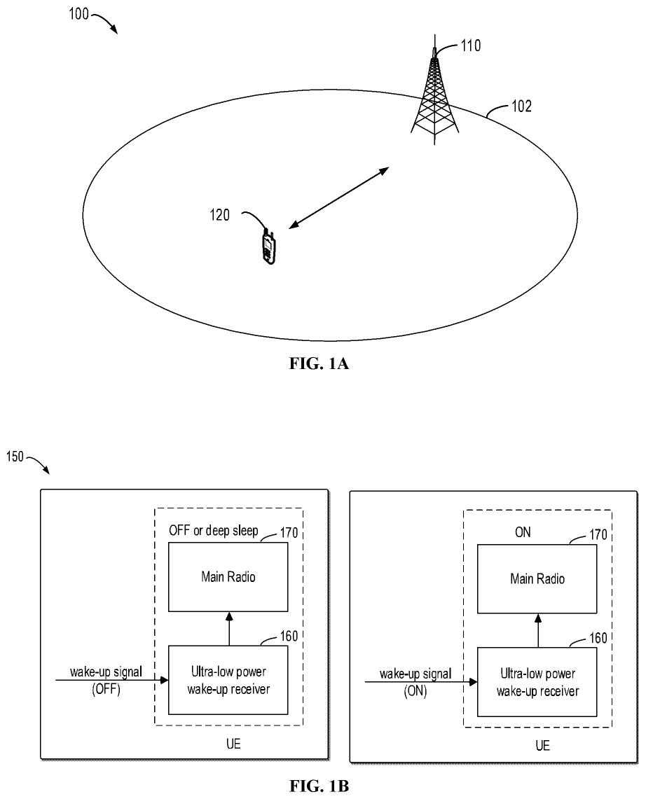

FIG. 1A illustrates an example of a network environment 100 in which some example embodiments of the present disclosure may be implemented. In the descriptions of the example embodiments of the present disclosure, the network environment 100 may also be referred to as a communication system 100 (for example, a portion of a communication network). For illustrative purposes only, various aspects of example embodiments will be described in the context of one or more terminal devices and network devices (which can also be referred to as “network node” in this disclosure) that communicate with one another. It should be appreciated, however, that the description herein may be applicable to other types of apparatus or other similar apparatuses that are referenced using other terminology.

The network device 110 can provide services to the terminal device 120, and the network device 110 and the terminal device 120 may communicate data and control information with each other. In some embodiments, the network device 110 and the terminal device 120 may communicate with direct links/channels. As used herein, the network device 110 can be also termed as a network device 110 in some example embodiments.

In the communication system 100, a link from the network device 110 to the terminal device 120 is referred to as a downlink (DL), while a link from the terminal device 120 to the network device 110 is referred to as an uplink (UL). In downlink, the network device 110 is a transmitting (TX) device (or a transmitter) and the terminal device 120 is a receiving (RX) device (or a receiver). In uplink, the terminal device 120 is a transmitting (TX) device (or a transmitter) and the network device 110 is a RX device (or a receiver). It is to be understood that the network device 110 may provide one or more serving cells. As illustrated in FIG. 1A, the network device 110 provides one serving cell 102, and the terminal device 120 camps on the serving cell 102. In some embodiments, the network device 110 can provide multiple serving cells. It is to be understood that the number of serving cell(s) shown in FIG. 1A is for illustrative purposes only without suggesting any limitation.

Communications in the network environment 100 may be implemented according to any proper communication protocol(s), comprising, but not limited to, cellular communication protocols of the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

It is to be understood that the number of devices and their connection relationships and types shown in FIG. 1A are for illustrative purposes only without suggesting any limitation. The communication system 100 may comprise any suitable number of devices adapted for implementing embodiments of the present disclosure.

As described above, 5G systems are designed and developed targeting for both mobile telephony and vertical use cases. Besides latency, reliability, and availability, UE energy efficiency is also critical to 5G. Currently, 5G devices may have to be recharged per week or day, depending on individual's usage time. In general, 5G devices consume tens of milliwatts in RRC idle/inactive state and hundreds of milliwatts in RRC connected state. Designs to prolong battery life are necessary for improving energy efficiency as well as for better user experience.

Energy efficiency is even more critical for UEs without a continuous energy source, e.g., UEs using small rechargeable and single coin cell batteries. Among vertical use cases, sensors and actuators are deployed extensively for monitoring, measuring, charging, etc. Generally, their batteries are not rechargeable and expected to last at least few years as described in 3GPP TR 38.875. Wearables include smart watches, rings, eHealth related devices, and medical monitoring devices. With typical battery capacity, it is challenging to sustain up to 1-2 weeks as required.

The power consumption depends on the configured length of wake-up periods, e.g., paging cycle. To meet the battery life requirements above, extended discontinuous reception (eDRX) cycle with large value is expected to be used, resulting in high latency, which is not suitable for such services with requirements of both long battery life and low latency. For example, in fire detection and extinguishment use case, fire shutters shall be closed and fire sprinklers shall be turned on by the actuators within 1 to 2 seconds from the time the fire is detected by sensors, long eDRX cycle cannot meet the delay requirements. eDRX is apparently not suitable for latency-critical use cases. Thus, the intention is to study ultra-low power mechanism that can support low latency in Rel-18, e.g. lower than eDRX latency.

Currently, UEs need to periodically wake up once per DRX cycle, which dominates the power consumption in periods with no signaling or data traffic. If UEs are able to wake up only when they are triggered, e.g., paging, power consumption could be dramatically reduced. This can be achieved by using a wake-up signal to trigger the main radio and a separate receiver which has the ability to monitor wake-up signal with ultra-low power consumption. Main radio works for data transmission and reception, which can be turned off or set to deep sleep unless it is turned on. This will be described in more detail with reference to FIG. 1B.

FIG. 1B illustrates a schematic diagram of operations of UE 150 with low-power wake-up receiver (WUR) based on which some example embodiments of the present disclosure may be implemented. Such a UE 150 primarily targets low-power WUS/WUR for power-sensitive, small form-factor devices including IoT use cases (such as industrial sensors, controllers) and wearables. Other use cases, e.g., augmented reality (AR), virtual reality (VR), extended reality (XR), smart glasses, smart phones, are not precluded. As illustrated in FIG. 1B, the UE 150 includes a main radio 170 and a separate receiver, i.e., an ultra-low power wake-up receiver 160.

The main radio 170 of the UE 150 can be in a sleep mode (or even powered off) for power saving and be activated only upon the reception of the wake-up signal from the network (e.g., from a network device). Basically, the network triggers the UE 150 to wake-up exactly when needed in an event-driven manner, by transmitting a special WUS to the UE 150, which is monitored by the dedicated low-power WUS receiver 160 at the UE 150. When the UE 150 receives the WUS, the WUS receiver 160 can trigger the wake-up of the ordinary NR transceiver (which is included in the main radio 170) and communication can start. Thus, the ultra-low power wake-up receiver 160 wakes up the main radio 170 and otherwise, the main radio 170 is OFF or kept in a deep sleep mode, as shown in FIG. 1B.

Strictly speaking, the power consumption for monitoring wake-up signal depends on the wake-up signal design and the hardware module of the wake-up receiver used for signal detecting and processing. Whereas, the assumption is that the low-power wake-up receiver 160 can be operated in an always ‘on’ manner with very low power consumption. In fact, it is expected that it will consume significantly less power compared to the NR transceiver, by designing a simple (WUS) signal and the use of dedicated hardware for its monitoring, which is only able to receive the WUS.

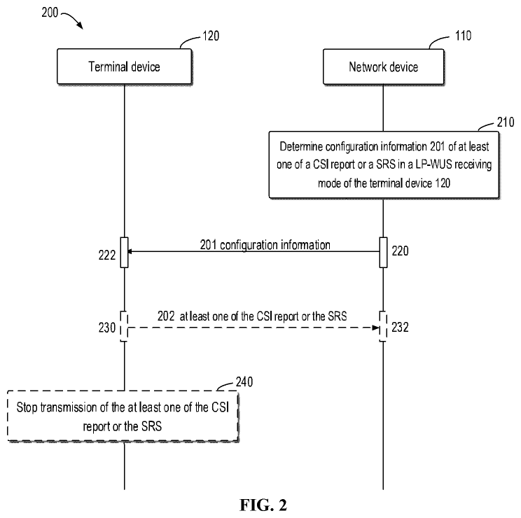

FIG. 2 illustrates a flowchart illustrating a communication process 200 in accordance with some example embodiments of the present disclosure. For the purpose of discussion, the communication process 200 will be described with reference to FIGS. 1A and 1B. It would be appreciated that although the communication process 200 has been described referring to the network environment 100 of FIG. 1A, this communication process 200 may be likewise applied to other similar communication scenarios.

As illustrated in FIG. 2, the network device 110 determines (210) configuration information 201 of at least one of a channel-state information (CSI) report or a sounding reference signal (SRS) in a low power wake-up signal (LP-WUS) monitoring mode of the terminal device 120. In one example, the configuration information 201 may indicate that transmission of the at least one of the CSI report or the SRS is to be stopped when the terminal device 120 is in the LP-WUS monitoring mode. In another example, the configuration information 201 may include a timer for the transmission of the at least one of the CSI report or the SRS. In this case, for example, the configuration information 201 may configure the terminal device 120 to start the timer when the terminal device 120 starts to monitor the LP-WUS, and to stop the transmission of the at least one of the CSI report or the SRS when the timer expires. In this case, in another example, the configuration information 201 may configure the terminal device 120 to start the timer when the terminal device 120 starts to monitor the LP-WUS, and to start the transmission of the at least one of the CSI report or the SRS when the timer expires.

In some example embodiments, the configuration information 201 may indicate a first transmission configuration and a second transmission configuration different from the first transmission configuration. The first transmission configuration can be used for transmission of the at least one of the CSI report or the SRS when the terminal device is in a physical downlink control channel (PDCCH) monitoring mode or not in the LP-WUS monitoring mode. The second transmission configuration may be used for transmission of the at least one of the CSI report or the SRS when the terminal device is in the LP-WUS monitoring mode. In some instances, the first transmission configuration can include a first periodicity and the second transmission configuration can include a second periodicity different from the first periodicity. Alternatively or additionally, the CSI report or the SRS or both of them may be periodic or semi-persistent (SP). Alternatively or additionally, the first transmission configuration and the second transmission configuration may be indicated by the network device 110 from a set of transmission configurations. In the case that the first transmission configuration includes a first periodicity and the second transmission configuration includes a second periodicity different from the first periodicity, the second periodicity may be a multiple of the first periodicity. In some instances, an offset value can be configured between a first transmission occasion of the at least one of the CSI report or the SRS in a period of the first periodicity and a second transmission occasion of the at least one of the CSI report or the SRS in a period of the second periodicity.

For example, the configuration information 201 may indicate a first CSI/SRS transmission configuration in a PDCCH monitoring mode or in the mode where LP-WUS is not monitored and a second CSI/SRS transmission configuration in the LP-WUS monitoring mode. The first CSI/SRS transmission configuration may be different from the first transmission configuration. In one example, the first CSI/SRS transmission configuration comprises a first periodicity and the second CSI/SRS transmission configuration comprises a second periodicity different from the first periodicity. In another example, the at least one of the CSI report or the SRS may be periodic or semi-persistent (SP). In yet another example, the first CSI/SRS transmission configuration and the second CSI/SRS transmission configuration are indicated by the network device 110 from a set of transmission configurations. The second periodicity may be a multiple of the first periodicity. As an example, the first periodicity may be 20 ms, and the second periodicity may be 100 ms, in which case the second periodicity is 5 times of the first periodicity. In some examples, the same transmission occasion(s) are used for CSI reporting or SRS transmission in the case where the second periodicity is a multiple of the first periodicity. As another example, an offset value may be configured between the first transmission occasion of the at least one of the CSI report or the SRS in a period of the first periodicity and a second transmission occasion of the at least one of the CSI report or the SRS in a period of the second periodicity. For example, if the first periodicity may be 20 ms, and the second periodicity may be 100 ms, the offset value may be set as 22 ms or any other suitable value. As another example, an offset value may be configured for the LP-WUS monitoring mode where the second periodicity is a multiple of a first periodicity. In this case, the offset value may be used to determine the transmission occasion of a CSI reporting or SRS transmission from the transmission occasions of the first periodicity within the second periodicity.

In some example embodiments, the network device 110 may indicate the terminal device 120 to start the LP-WUS monitoring mode. For instance, when the terminal device 120 is in a PDCCH monitoring mode or in a mode where LP-WUS is not monitored, the network device 110 may indicate the UE to start the LP-WUS monitoring mode. In some examples, when the network device 110 indicates the terminal device 120 to start the LP-WUS monitoring mode, network device 110 may indicate to the terminal device 120 whether CSI reporting and/or SRS transmission is performed while the terminal device 120 is in the LP-WUS monitoring mode.

In some example embodiments, the configuration information 201 may indicate a first TAT and a second TAT. The first TAT may be used for a PDCCH monitoring mode of the terminal device 120 or in the mode where LP-WUS is not monitored, and the second TAT may be used for the LP-WUS monitoring mode of the terminal device 120. An expiry time of the second TAT may be shorter than an expiry time of the first TAT. For example, the expiry time of the first TAT used for a PDCCH monitoring mode may be 18 ms, and the expiry time of the second TAT may be 16 ms, which is shorter than the expiry time of the first TAT.

As further illustrated in FIG. 2, the network device 110 transmits (220) the configuration information 201 to the terminal device 120. On the other side of communication, the terminal device receives (222) the configuration information 201 from the network device 110. In some other example embodiments, prior to a time alignment timer (TAT) configured for the terminal device 120 expires when the terminal device 120 is in the LP-WUS monitoring mode, the network device 110 may transmit an LP-WUS and a TAC MAC CE to the terminal device 120.

In some example embodiments, the terminal device 120 can further transmit to the network device 110 and while the terminal device 120 is in the LP-WUS monitoring mode, the CSI report or the SRS or both of them, based on the configuration information 201 indicating that the CSI report or the SRS or both of them is to be transmitted in the LP-WUS monitoring mode. As an example, as illustrated in FIG. 2, the terminal device 120 may transmit (230) at least one of the CSI report or the SRS 202 to the network device 110 based on the configuration information 201 while the terminal device 120 is in the LP-WUS monitoring mode. For example, the terminal device 120 may transmit (230), to the network device 110, the at least one of the CSI report or the SRS 202 while the terminal device 120 is in the LP-WUS monitoring mode based on the configuration information 201 which indicates that the at least one of the CSI report or the SRS 202 is to be transmitted in the LP-WUS receiving mode. Here, the at least one of the CSI report or the SRS 202 indicates the CSI report or the SRS or both of them. On the other side of communication, the network device 110 may receive (232) the at least one of the CSI report or the SRS 202 from the terminal device 120. Alternatively, as another example, as at block 240 illustrated in FIG. 2, the terminal device 120 may stop the transmission of the at least one of the CSI report or the SRS 202 when the terminal device 120 is in the LP-WUS monitoring mode. For example, the terminal device 120 may stop the transmission of the at least one of the CSI report or the SRS 202 when the terminal device 120 is in the LP-WUS receiving mode based on the configuration information 201, which indicates that transmission of the at least one of the CSI report or the SRS 202 is to be stopped in the LP-WUS receiving mode.

In some example embodiments, the terminal device 120 may enter the LP-WUS monitoring mode, and monitor the LP-WUS during the LP-WUS monitoring mode, based on the received configuration information 201. As an example, the terminal device 120 may be configured to enter the LP-WUS monitoring mode at the beginning of an onDuration/Active timer when connected mode DRX is configured. Then, the terminal device 120 may apply the second transmission configuration for CSI reporting and/or SRS transmission. In addition or alternatively, the terminal device 120 may, based on the configuration information indicating that transmission of the at least one of the CSI report or the SRS is to be stopped in the LP-WUS monitoring mode, stop the transmission of the at least one of the CSI report or the SRS when the terminal device 120 is in the LP-WUS monitoring mode. As an example, based on the configuration information 201 indicating that transmission of the at least one of the CSI report or the SRS 202 is to be stopped in the LP-WUS monitoring mode, the terminal device 120 may stop the transmission of the CSI/SRS when the terminal device 120 is in the LP-WUS monitoring mode. As another example, in stopping the at least one of the CSI report or the SRS 202, the terminal device 120 may start the timer when the terminal device 120 starts to monitor the LP-WUS, and stops the transmission of the at least one of the CSI report or the SRS 202 when the timer expires. As another example, the terminal device 120 does not transmit CSI report or the SRS while in the LP-WUS monitoring mode. In this example, the terminal device 120 may not receive any configuration information 201 to determine it may not transmit CSI report or the SRS while in the LP-WUS monitoring mode.

In some example embodiments, based on receiving an LP-WUS from the network device 110, the terminal device 120 may further switch from the LP-WUS monitoring mode to the PDCCH monitoring mode, deactivate the second transmission configuration and activate the first transmission configuration. In addition or alternatively, the terminal device 120 may either start the second TAT based on monitoring the LP-WUS or restart the first TAT and the second TAT based on receiving the TAC MAC CE. In some example embodiments, the terminal device 120 may be configured with connected mode discontinuous reception (DRX), and may enter LP-WUS receiving mode at beginning of an onDuration/Active timer prior to receiving the LP-WUS.

In some example embodiments, based on determining that a TAT expires when the apparatus is in the LP-WUS monitoring mode, the terminal device 120 may further perform at least one of: storing a timing advance (TA) value; suspending an uplink configuration (for example, physical uplink control channel (PUCCH), SRS, configured DL assignment/UL grant, physical uplink shared channel (PUSCH) for semi-persistent (SP)-CSI, etc.); or avoiding flushing a hybrid automatic repeat request (HARQ) buffer for a HARQ process.

In some example embodiments, after switching from the LP-WUS monitoring mode to a PDCCH monitoring mode, the terminal device 120 may further receive a message from the network device 110 after receiving the LP-WUS. Based on determining that the message comprises a TAC MAC CE, the terminal device 120 may perform at least one of: restarting the TAT based on the stored TA value, restoring the uplink configuration, and continuing the HARQ process. In addition, based on determining that the message does not comprise the TAC MAC CE, the terminal device 120 may further perform at least one of: releasing the uplink configuration, clearing at least one of a downlink/uplink configured grant or a PUSCH for SP-CSI; and flushing the HARQ buffer for the HARQ process.

Through the process flow 200, UL-synchronization can be kept when the UE is in LP-WUS monitoring mode.

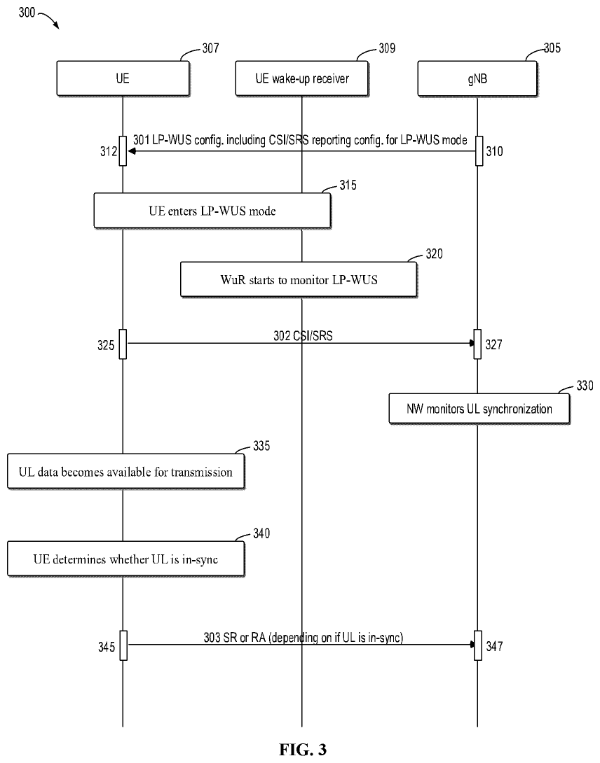

FIG. 3 illustrates an example of a process flow 300 for CSI/SRS reporting in LP-WUS monitoring mode in accordance with some example embodiments of the present disclosure. For the purpose of discussion, the process flow 300 will be described with reference to FIGS. 1A-2. It would be appreciated that although the process flow 300 has been described referring to the network environment 100 of FIG. 1A, this process flow 300 may be likewise applied to other similar communication scenarios. It is noted that the process flow 300 can be considered as an example embodiment of the communication process 200 as discussed hereinbefore. Thus, the UE 307 may be an example of the terminal device 120 in FIG. 1A or FIG. 2 or UE 150 in FIG. 1B, the UE wake-up receiver 309 may be a part of the UE 307 and may be an example of the ultra-low power wake-up receiver 160 in FIG. 1B, and the gNB 305 can be considered as an example of the network device 110 in FIG. 1 or 2.

As illustrated in FIG. 3, in the process flow 300, the network device (denoted as “gNB”) 305 may transmit (310) an LP-WUS configuration 301 to the terminal device (denoted as “UE”) 307, for example, to configure an LP-WUS monitoring mode for the UE 307. The LP-WUS configuration 301 includes CSI/SRS reporting configuration for LP-WUS monitoring mode. On the other side of communication, the UE 307 receives (312) the LP-WUS configuration 301 from the gNB 305.

In the LP-WUS configuration 301, different periodicity for CSI reporting and/or SRS transmission can be configured respectively in cases when the UE 307 is monitoring only Low Power-WUS (called as LP-WUS monitoring mode hereafter) and after the UE is waken up by WUS. Since there is no data scheduling when the UE 307 is monitoring only LP-WUS, SRS/CSI reporting periodicity for synchronization could be much longer than the one for data scheduling when the main receiver (e.g., the receiver included in the main radio 170 as illustrated in FIG. 1B) is on.

Continuing with reference to FIG. 3, after receiving (312) LP-WUS configuration 301 from the gNB 305 and being configured the LP-WUS monitoring mode by the gNB 305, at block 315, UE 307 (including its inside wake-up receiver 309) may enter the LP-WUS monitoring mode. Upon entering the LP-WUS monitoring mode, at block 320, the UE wake-up receiver (WuR) 309 may start to monitor LP-WUS. The reception of an LP-WUS that wakes up the main receiver could be considered as activation of a different SRS/CSI reporting pattern/resource/configuration. As an example, it could be applicable to periodic CSI reporting/SRS and/or SP-CSI reporting/SP-SRS. As another example, the NW could indicate which CSI-ReportConfigId to activate respectively when the UE 307 is monitoring the LP-WUS and after it is waken up. As still another example, the one that is used in the other mode is automatically considered as deactivated for SP-CSI reporting/SP-SRS. As a specific example, in the LP-WUS configuration 301, there are different configurations for SP-CSI reporting in LP-WUS monitoring mode and normal PDCCH monitoring mode. In this case, these two modes do not co-exist. In other words, activation of LP-WUS monitoring mode indicates deactivation of normal PDCCH monitoring mode, and vice versa (i.e., activation of normal PDCCH monitoring mode indicates deactivation of LP-WUS monitoring mode).

After the WuR starts to monitor LP-WUS at block 320, the UE 307 may transmit (325) CSI/SRS 302 to the gNB 305 according to LP-WUS configuration 301. CSI/SRS 302 may include at least one of CSI report or the SRS.

In some example embodiments, the periodicity for CSI reporting/SRS transmission/SP-CSI reporting/SP-SRS etc. used in LP-WUS monitoring mode is multiple of the periodicity in normal PDCCH monitoring mode while the resource remains the same. As an example, the gNB 305 can configure a multiplication factor that is used to determine the periodicity for the LP-WUS monitoring mode. In this case, if the periodicity for CSI reporting/SRS transmission/SP-CSI reporting/SP-SRS is, for example, 20 ms in normal PDCCH monitoring, the multiplication factor is configured to be 5, then it means the periodicity for CSI reporting/SRS transmission/SP-CSI reporting/SP-SRS in LP-WUS monitoring mode is 100 ms (=20 ms×5). The multiplication factor may be configured in the LP-WUS configuration 301, and also may be configured (or re-configured) with a separate signaling, for example, via an RRCConfiguration message or an RRCReconfiguration message. It is to be noted that the multiplication factor can be determined and configured as any suitable value based on the network conditions and required communication performance, which may comprise but be not limited to uplink channel status, frequency of LP-WUS transmission, frequency of UL data transmission, environment interference, etc.

Furthermore, as another example, an offset value could be configured so that UE 307 knows which occasion to use out from the multiple occasions within one period with LP-WUS monitoring mode. This also ensures UL synchronization between the gNB 305 and the UE 307 for the CSI reporting/SRS transmission. Specifically, in this case, if the periodicity for CSI reporting/SRS transmission/SP-CSI reporting/SP-SRS is 20 ms in normal PDCCH monitoring, the offset value may be configured as, for example, 60 ms, then it means the periodicity for CSI reporting/SRS transmission/SP-CSI reporting/SP-SRS in LP-WUS monitoring mode is 120 ms (=20 ms+60 ms).

Alternatively, in some other example embodiments, the UE 307 stops ongoing CSI reporting and/or SRS transmission in LP-WUS monitoring mode, i.e., the UE 307 is monitoring LP-WUS only. Conditions for stopping CSI reporting and/or SRS transmission can be time based, for example, if the time elapsed after the UE 307 has been in LP-WUS monitoring mode without data transmission has reached a threshold. The threshold may be configured by the gNB 305. In doing so, battery of the UE 307 can be saved, and it helps to ensure the UL orthogonality by preventing badly/wrongly synchronized UL transmissions (if the DL synchronization of the UE 307 is drifting during the LP-WUS monitoring mode). However, random access procedure for UL synchronization after the UE 307 is waken up with LP-WUS, which may be relatively time-consuming.

On the other side of communication, the gNB 305 may receive (327) the CSI/SRS 302 from the UE 307. At block 330, the gNB 305 (representing the network) monitors UL synchronization. For example, upon reception of CSI reporting/SRS when the UE 307 is in LP-WUS, the gNB 305 can use LP-WUS to wake up the main receiver and then send TAC MAC CE.

As illustrated in FIG. 3, at block 335, UL data becomes available for transmission at UE 307. In order to transmit the UL data to the gNB 305, the UE 307 may, at block 340, determine whether UL is in-sync, because the UL data can be successfully received by the gNB 305 only when the UL synchronization is established between the UE 307 and the gNB 305. Depending on whether UL is in-sync, the UE 307 may transmit (345) a scheduling request (SR) or random access (RA) message to the gNB 305. Specifically, if UL is in-sync, RA procedure is not necessary, so the UE 307 transmits (345) an SR message for resource allocation to transmit the UL data. Alternatively, if UL is not in-sync, RA procedure is necessary, so the UE 307 transmits (345) an RA message to re-establish connection with the gNB 305 to obtain UL synchronization with the gNB 305. The subsequent UL data transmission follows the legacy scheme, and thus the detailed description is omitted here.

Also, it is to be noted that, for CSI reporting, the UE 307 needs to wake up the main receiver as well as for CSI measurement, but less frequently and no explicit indication is needed. The UE 307 can perform the measurement based on the report configuration. While for SRS transmission, downlink (DL) reception on the main receiver is required mainly to keep synchronization.

Through the process flow 300, UL-synchronization can be kept when the UE is in LP-WUS monitoring mode.

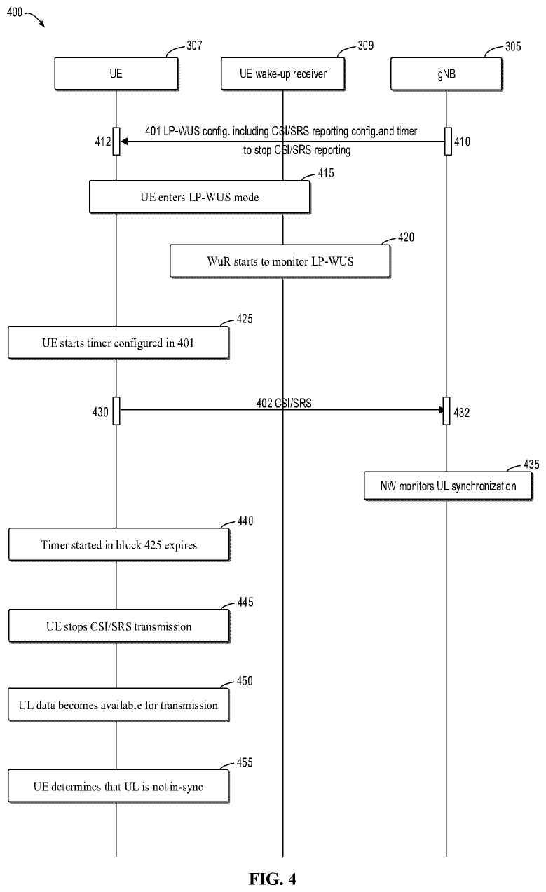

FIG. 4 illustrates an example of a process flow 400 for stopping CSI/SRS reporting in LP-WUS monitoring mode in accordance with some example embodiments of the present disclosure. For the purpose of discussion, the process flow 400 will be described with reference to FIGS. 1A-3. It would be appreciated that although the process flow 400 has been described referring to the network environment 100 of FIG. 1A, this process flow 400 may be likewise applied to other similar communication scenarios. It is noted that the process flow 400 can be considered as another example embodiment of the communication process 200 as discussed hereinbefore. Thus, the UE 307 may be an example of the terminal device 120 in FIG. 1A or FIG. 2 or UE 150 in FIG. 1B, the UE wake-up receiver 309 may be a part of the UE 307 and may be an example of the ultra-low power wake-up receiver 160 in FIG. 1B, and the gNB 305 can be considered as an example of the network device 110 in FIG. 1A or 2.

As illustrated in FIG. 4, in the process flow 400, the gNB 305 may transmit (410) an LP-WUS configuration 401 to UE 307, for example, to configure CSI/SRS reporting configuration in an LP-WUS monitoring mode and also a timer to stop the CSI/SRS reporting for the UE 307. The LP-WUS configuration 401 includes CSI/SRS reporting configuration in the LP-WUS monitoring mode and also a timer to stop the CSI/SRS reporting for the UE 307. On the other side of communication, the UE 307 receives (412) the LP-WUS configuration 401 from the gNB 305.

After receiving (412) LP-WUS configuration 401 from the gNB 305 and being configured the LP-WUS monitoring mode by the gNB 305, at block 415, UE 307 (including its inside wake-up receiver 309) may enter the LP-WUS monitoring mode. Upon entering the LP-WUS monitoring mode, at block 420, the UE wake-up receiver (WuR) 309 may start to monitor LP-WUS. The operations in blocks 415 and 420 are the same as those in blocks 315 and 320 as illustrated in FIG. 3, thus FIG. 3 may be referred to for detailed description.

At block 425, the UE 307 may start the timer to stop CSI/SRS reporting, as configured in the LP-WUS configuration 401. From then on, the UE 307 may transmit (430) CSI/SRS 402 to the gNB 305 according to LP-WUS configuration 401. On the other side of communication, the gNB 305 may receive (432) the CSI/SRS 402 from the UE 307. Based on the received CSI/SRS 402, at block 435, the gNB 305 monitors UL synchronization. The CSI/SRS 402 may be the same as CSI/SRS 302 as illustrated in FIG. 3, thus FIG. 3 may be referred to for detailed description.

In some example embodiments, a common TAT is configured at the UE 307 and the gNB 305. In this case, since LP-WUS monitoring mode could take the configured TAT into account, it can be ensured that TAT would not expire at the gNB 305 before receiving UL transmission from the UE 307 for timing estimation.

In some other example embodiments, normal PDCCH monitoring mode and LP-WUS monitoring mode have been configured with separate (different) TATs. For example, the UE 307 may re-start both TATs upon receiving TAC MAC CE. In one example, UE 307 starts TAT associated with LP-WUS monitoring mode when it monitors only LP-WUS while the TAT used for normal PDCCH monitoring is running as in legacy schemes. In another example, the TAT used for LP-WUS monitoring mode is shorter than the TAT used for normal PDCCH monitoring mode. As an example, the TAT used for LP-WUS monitoring mode may be 30 ms, which is shorter than the TAT used for normal PDCCH monitoring mode, which is, for example, 50 ms.

As illustrated in FIG. 4, at block 440, the timer to stop CSI/SRS reporting, which is started in block 425, expires. In some example embodiments, upon TAT expiry while in LP-WUS monitoring mode, the UE 307 stores the TA value (NTA), suspends its UL configuration (e.g., PUCCH, SRS, configured DL assignment/UL grant, PUSCH for SP-CSI etc.) and does not flush HARQ buffers until first message from the gNB 305 after LP-WUS indication to wake up main radio (e.g., the main radio 170 as illustrated in FIG. 1B). If the gNB 305 indicates TAC MAC CE in the first PDSCH message, UE 307 restarts TAT based on the stored NTA value, restores the suspended UL configurations and continues HARQ. Whereas, if the gNB 305 does not indicate TAC MAC CE or does not provide DL assignment for PDSCH after the LP-WUS indication, UE 307 releases PUCCH and SRS configurations, clears any DL/UL CGs and PUSCH for SP-CSI, and flushes all HARQ buffers.

After expiration of the timer to stop CSI/SRS reporting, at block 445, the UE 307 stops CSI/SRS transmission to the gNB 305.

Later, at block 450, UL data becomes available for transmission at UE 307. In this case, the UE 307 does not need to determine whether UL is in-sync, because the UE 307 may directly determine (455) that UL is not in-sync with the gNB 305. Thus, in order to transmit the UL data to the gNB 305, the UE 307 may directly transmit an RA message to re-establish connection with the gNB 305 to obtain UL synchronization with the gNB 305. The subsequent UL data transmission may follow the legacy scheme, and thus the detailed description is omitted here.

Through the process flow 400, UL-synchronization can be kept when the UE is in LP-WUS monitoring mode.

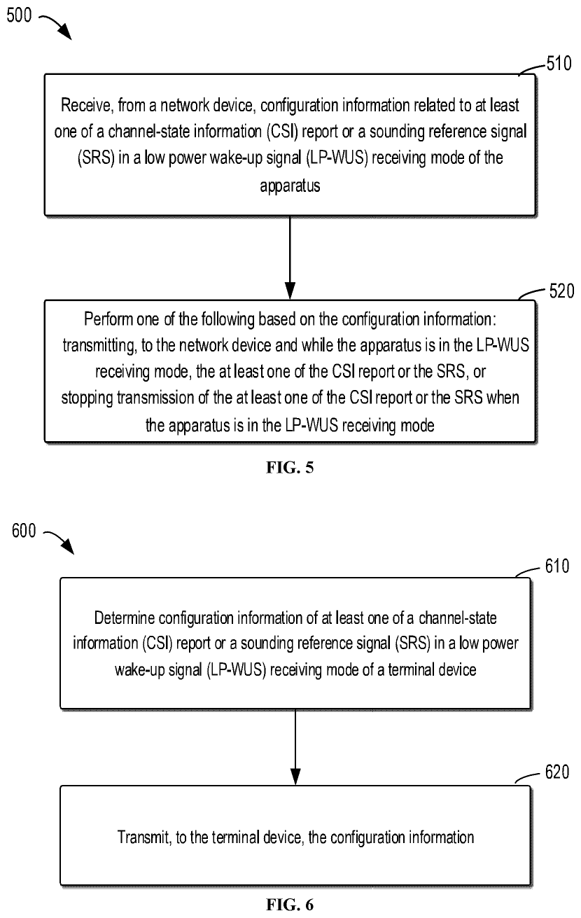

FIG. 5 illustrates a flowchart of an example method 500 implemented at a terminal device in accordance with some other embodiments of the present disclosure. For the purpose of discussion, the method 500 will be described from the perspective of the terminal device 120 with reference to FIGS. 1A-2.

At block 510, the terminal device 120 receives, from a network device, configuration information related to at least one of a channel-state information (CSI) report or a sounding reference signal (SRS) in a low power wake-up signal (LP-WUS) monitoring mode of the terminal device 120. At block 520, the first device 120 performs one of the following based on the configuration information: transmitting, to the network device and while the terminal device 120 is in the LP-WUS monitoring mode, the at least one of the CSI report or the SRS, or stopping transmission of the at least one of the CSI report or the SRS when the terminal device is in the LP-WUS receiving mode.

In some example embodiments, the terminal device 120 may enter the LP-WUS monitoring mode, and monitor the LP-WUS during the LP-WUS monitoring mode.

In some example embodiments, in performing the transmitting, based on the configuration information which indicates that the at least one of the CSI report or the SRS is to be transmitted in the LP-WUS receiving mode, the terminal device 120 transmits, to the network device 110, the at least one of the CSI report or the SRS while the terminal device 120 is in the LP-WUS receiving mode.

In some example embodiments, in performing the stopping, based on the configuration information which indicates that transmission of the at least one of the CSI report or the SRS is to be stopped in the LP-WUS receiving mode, the terminal device 120 stops the transmission of the at least one of the CSI report or the SRS when the terminal device 120 is in the LP-WUS receiving mode.

In some example embodiments, based on the configuration information indicating that transmission of the at least one of the CSI report or the SRS is to be stopped in the LP-WUS monitoring mode, the terminal device 120 can stop the transmission of the at least one of the CSI report or the SRS when the terminal device 120 is in the LP-WUS monitoring mode.

In some example embodiments, the configuration information comprises a timer for the transmission of the at least one of the CSI report or the SRS.

In some example embodiments, stopping the transmission comprises: starting the timer when the terminal device 120 starts to monitor the LP-WUS; and stopping the transmission of the at least one of the CSI report or the SRS when the timer expires.

In some example embodiments, the configuration information indicates a first transmission configuration and a second transmission configuration different from the first transmission configuration; the first transmission configuration is used for transmission of the at least one of the CSI report or the SRS when the terminal device 120 is in a physical downlink control channel (PDCCH) monitoring mode; and the second transmission configuration is used for the transmission of the at least one of the CSI report or the SRS when the terminal device 120 is in the LP-WUS monitoring mode.

In some example embodiments, based on receiving an LP-WUS from the network device, the terminal device 120 may switch from the LP-WUS monitoring mode to the PDCCH monitoring mode; and deactivate the second transmission configuration; and activating the first transmission configuration.

In some example embodiments, the terminal device 120 may be configured with connected mode discontinuous reception (DRX), and prior to receiving the LP-WUS, the terminal device 120 may enter LP-WUS receiving mode at beginning of an onDuration/Active timer.

In some example embodiments, the first transmission configuration comprises a first periodicity and the second transmission configuration comprises a second periodicity different from the first periodicity. Alternatively or additionally, the at least one of the CSI report or the SRS is periodic or semi-persistent (SP). Alternatively or additionally, the first transmission configuration and the second transmission configuration are indicated by the network device from a set of transmission configurations.

In some example embodiments, the second periodicity is a multiple of the first periodicity.

In some example embodiments, an offset value is configured between a first transmission occasion of the at least one of the CSI report or the SRS in a period of the first periodicity and a second transmission occasion of the at least one of the CSI report or the SRS in a period of the second periodicity.

In some example embodiments, the configuration information indicates a first time alignment timer (TAT) and a second TAT; the first TAT is used for a PDCCH monitoring mode of the terminal device 120; and the second TAT is used for the LP-WUS monitoring mode of the terminal device 120.

In some example embodiments, based on monitoring the LP-WUS, the terminal device 120 may start the second TAT. Alternatively or additionally, based on receiving the TAC MAC CE, the terminal device 120 may restart the first TAT and the second TAT.

In some example embodiments, an expiry time of the second TAT is shorter than an expiry time of the first TAT.

In some example embodiments, based on determining that a TAT expires when the terminal device 120 is in the LP-WUS monitoring mode, the terminal device 120 can perform at least one of: storing a timing advance (TA) value; suspending an uplink configuration; or avoiding flushing a hybrid automatic repeat request (HARQ) buffer for a HARQ process.

In some example embodiments, after switching from the LP-WUS monitoring mode to a PDCCH monitoring mode, the terminal device 120 can receive a message from the network device after receiving the LP-WUS; based on determining that the message comprises a TAC MAC CE, the terminal device 120 may perform at least one of the following: restarting the TAT based on the stored TA value; restoring the uplink configuration; and continuing the HARQ process.

In some example embodiments, based on determining that the message does not comprise the TAC MAC CE, the terminal device 120 can perform at least one of: releasing the uplink configuration; clearing at least one of a downlink/uplink configured grant or a physical uplink shared channel (PUSCH) for SP-CSI; and flushing the HARQ buffer for the HARQ process.

FIG. 6 illustrates another flowchart of an example method 600 implemented at a network device in accordance with some other embodiments of the present disclosure. For the purpose of discussion, the method 600 will be described from the perspective of the network device 110 with reference to FIGS. 1A-2.

At block 610, the network device 110 determines configuration information of at least one of a channel-state information (CSI) report or a sounding reference signal (SRS) in a low power wake-up signal (LP-WUS) monitoring mode of a terminal device 120. At block 620, the network device 110 transmits, to the terminal device 120, the configuration information.

In some example embodiments, the configuration information indicates that transmission of the at least one of the CSI report or the SRS is to be stopped when the terminal device is in the LP-WUS monitoring mode.

In some example embodiments, the configuration information comprises a timer for the transmission of the at least one of the CSI report or the SRS.

In some example embodiments, the configuration information configures the terminal device to start the timer when the terminal device starts to monitor the LP-WUS, and to stop the transmission of the at least one of the CSI report or the SRS when the timer expires.

In some example embodiments, the configuration information indicates a first transmission configuration and a second transmission configuration different from the first transmission configuration; the first transmission configuration is used for transmission of the at least one of the CSI report or the SRS when the terminal device is in a physical downlink control channel (PDCCH) monitoring mode; and the second transmission configuration is used for transmission of the at least one of the CSI report or the SRS when the terminal device is in the LP-WUS monitoring mode.

In some example embodiments, the first transmission configuration comprises a first periodicity and the second transmission configuration comprises a second periodicity different from the first periodicity. Alternatively or additionally, the at least one of the CSI report or the SRS is periodic or semi-persistent (SP). Alternatively or additionally, the first transmission configuration and the second transmission configuration are indicated by the apparatus from a set of transmission configurations.

In some example embodiments, the second periodicity is a multiple of the first periodicity.

In some example embodiments, an offset value is configured between a first transmission occasion of the at least one of the CSI report or the SRS in a period of the first periodicity and a second transmission occasion of the at least one of the CSI report or the SRS in a period of the second periodicity.

In some example embodiments, prior to a time alignment timer (TAT) configured for the terminal device expires when the terminal device is in the LP-WUS monitoring mode, the network device 110 may transmit an LP-WUS to the terminal device; and transmit, to the terminal device, a timing advance command (TAC) media access control (MAC) control element (CE).

In some example embodiments, the configuration information indicates a first TAT and a second TAT; the first TAT is used for a PDCCH monitoring mode of the terminal device; and the second TAT is used for the LP-WUS monitoring mode of the terminal device.

In some example embodiments, an expiry time of the second TAT is shorter than an expiry time of the first TAT.

In some embodiments, an apparatus capable of performing the method 500 (for example, the terminal device 120) may comprise means for performing the respective steps of the method 500. The means may be implemented in any suitable form. For example, the means may be implemented in a circuitry or software module.

In some example embodiments, the apparatus comprises: means for receiving, from a network device, configuration information related to at least one of a channel-state information (CSI) report or a sounding reference signal (SRS) in a low power wake-up signal (LP-WUS) receiving mode of the apparatus; and means for performing one of the following based on the configuration information: transmitting, to the network device and while the apparatus is in the LP-WUS monitoring mode, the at least one of the CSI report or the SRS, or stopping transmission of the at least one of the CSI report or the SRS when the apparatus is in the LP-WUS receiving mode.

In some example embodiments, the apparatus further comprises: means for entering the LP-WUS monitoring mode; and means for monitoring the LP-WUS during the LP-WUS monitoring mode.

In some example embodiments, the means for performing comprises: based on the configuration information indicating that the at least one of the CSI report or the SRS is to be transmitted in the LP-WUS receiving mode, means for transmitting, to the network device, the at least one of the CSI report or the SRS while the apparatus is in the LP-WUS receiving mode.

In some example embodiments, the means for performing comprises: based on the configuration information indicating that transmission of the at least one of the CSI report or the SRS is to be stopped in the LP-WUS receiving mode, means for stopping the transmission of the at least one of the CSI report or the SRS when the apparatus is in the LP-WUS receiving mode.

In some embodiments, the configuration information comprises a timer for the transmission of the at least one of the CSI report or the SRS.

In some embodiments, the means for stopping the transmission comprises: means for starting the timer when the apparatus starts to monitor the LP-WUS; and means for stopping the transmission of the at least one of the CSI report or the SRS when the timer expires.

In some embodiments, the configuration information indicates a first transmission configuration and a second transmission configuration different from the first transmission configuration; the first transmission configuration is used for transmission of the at least one of the CSI report or the SRS when the apparatus is in a physical downlink control channel (PDCCH) monitoring mode; and the second transmission configuration is used for the transmission of the at least one of the CSI report or the SRS when the apparatus is in the LP-WUS monitoring mode.

In some embodiments, the apparatus further comprises: means for, based on receiving an LP-WUS from the network device, switching from the LP-WUS monitoring mode to the PDCCH monitoring mode; means for deactivating the second transmission configuration; and means for activating the first transmission configuration.

In some embodiments, the apparatus is configured with connected mode discontinuous reception (DRX), and the apparatus further comprises: prior to receiving the LP-WUS, means for entering LP-WUS receiving mode at beginning of an onDuration/Active timer.

In some embodiments, the first transmission configuration comprises a first periodicity and the second transmission configuration comprises a second periodicity different from the first periodicity. Alternatively or additionally, the at least one of the CSI report or the SRS is periodic or semi-persistent (SP). Alternatively or additionally, the first transmission configuration and the second transmission configuration are indicated by the network device from a set of transmission configurations.

In some embodiments, the second periodicity is a multiple of the first periodicity.

In some embodiments, an offset value is configured between a first transmission occasion of the at least one of the CSI report or the SRS in a period of the first periodicity and a second transmission occasion of the at least one of the CSI report or the SRS in a period of the second periodicity.

In some embodiments, the configuration information indicates a first time alignment timer (TAT) and a second TAT; the first TAT is used for a PDCCH monitoring mode of the apparatus; and the second TAT is used for the LP-WUS monitoring mode of the apparatus.

In some embodiments, the apparatus further comprises: means for, based on monitoring the LP-WUS, starting the second TAT; or based on receiving the TAC MAC CE, restarting the first TAT and the second TAT.

In some embodiments, an expiry time of the second TAT is shorter than an expiry time of the first TAT.

In some embodiments, the apparatus further comprises: means for, based on determining that a TAT expires when the apparatus is in the LP-WUS monitoring mode, performing at least one of: storing a timing advance (TA) value; suspending an uplink configuration; or avoiding flushing a hybrid automatic repeat request (HARQ) buffer for a HARQ process.

In some embodiments, the apparatus further comprises: means for, after switching from the LP-WUS monitoring mode to a PDCCH monitoring mode, receiving a message from the network device after receiving the LP-WUS; and means for, based on determining that the message comprises a TAC MAC CE, performing at least one of: restarting the TAT based on the stored TA value; restoring the uplink configuration; and continuing the HARQ process.

In some embodiments, the apparatus further comprises: means for, based on determining that the message does not comprise the TAC MAC CE, performing at least one of: releasing the uplink configuration; clearing at least one of a downlink/uplink configured grant or a physical uplink shared channel (PUSCH) for SP-CSI; and flushing the HARQ buffer for the HARQ process.

In some embodiments, the apparatus further comprises means for performing other steps in some embodiments of the method 500. In some embodiments, the means comprises at least one processor and at least one memory including computer program code, the at least one memory and computer program code configured to, with the at least one processor, cause the performance of the apparatus.

In some embodiments, an apparatus capable of performing the method 600 (for example, the network device 110) may comprise means for performing the respective steps of the method 600. The means may be implemented in any suitable form. For example, the means may be implemented in a circuitry or software module.

In some example embodiments, the apparatus comprises: means for determining configuration information of at least one of a channel-state information (CSI) report or a sounding reference signal (SRS) in a low power wake-up signal (LP-WUS) monitoring mode of a terminal device; and means for transmitting the configuration information to the terminal device.

In some embodiments, the configuration information indicates that transmission of the at least one of the CSI report or the SRS is to be stopped when the terminal device is in the LP-WUS monitoring mode.

In some embodiments, the configuration information comprises a timer for the transmission of the at least one of the CSI report or the SRS.

In some embodiments, the configuration information configures the terminal device to start the timer when the terminal device starts to monitor the LP-WUS, and to stop the transmission of the at least one of the CSI report or the SRS when the timer expires.

In some embodiments, the configuration information indicates a first transmission configuration and a second transmission configuration different from the first transmission configuration; the first transmission configuration is used for transmission of the at least one of the CSI report or the SRS when the terminal device is in a physical downlink control channel (PDCCH) monitoring mode; and the second transmission configuration is used for transmission of the at least one of the CSI report or the SRS when the terminal device is in the LP-WUS monitoring mode.

In some embodiments, the first transmission configuration comprises a first periodicity and the second transmission configuration comprises a second periodicity different from the first periodicity. Alternatively or additionally, the at least one of the CSI report or the SRS is periodic or semi-persistent (SP). Alternatively or additionally, the first transmission configuration and the second transmission configuration are indicated by the apparatus from a set of transmission configurations.

In some embodiments, the second periodicity is a multiple of the first periodicity.

In some embodiments, an offset value is configured between a first transmission occasion of the at least one of the CSI report or the SRS in a period of the first periodicity and a second transmission occasion of the at least one of the CSI report or the SRS in a period of the second periodicity.

In some embodiments, the apparatus further comprises: means for, prior to a time alignment timer (TAT) configured for the terminal device expires when the terminal device is in the LP-WUS monitoring mode, transmitting an LP-WUS to the terminal device; and means for transmitting, to the terminal device, a timing advance command (TAC) media access control (MAC) control element (CE).

In some embodiments, the configuration information indicates a first TAT and a second TAT; the first TAT is used for a PDCCH monitoring mode of the terminal device; and the second TAT is used for the LP-WUS monitoring mode of the terminal device.

In some embodiments, an expiry time of the second TAT is shorter than an expiry time of the first TAT.

In some embodiments, the apparatus further comprises means for performing other steps in some embodiments of the method 600. In some embodiments, the means comprises at least one processor and at least one memory including computer program code, the at least one memory and computer program code configured to, with the at least one processor, cause the performance of the apparatus.

FIG. 7 illustrates a simplified block diagram of a device 700 that is suitable for implementing some example embodiments of the present disclosure. The device 700 may be provided to implement a communication device, for example, the network device 110 or the terminal device 120 as shown in FIG. 1A. As shown, the device 700 includes one or more processors 710, one or more memories 720 coupled to the processor 710, and one or more communication modules 740 coupled to the processor 710.

The communication module 740 is for bidirectional communications. The communication module 740 has at least one antenna to facilitate communication. The communication interface may represent any interface that is necessary for communication with other network elements.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The program 730 may be stored in the ROM 724. The processor 710 may perform any suitable actions and processing by loading the program 730 into the RAM 722.

The embodiments of the present disclosure may be implemented by means of the program 730 so that the device 700 may perform any process of the disclosure as discussed with reference to FIGS. 2 to 3. The embodiments of the present disclosure may also be implemented by hardware or by a combination of software and hardware.

In some example embodiments, the program 730 may be tangibly contained in a computer-readable medium which may be included in the device 700 (such as in the memory 720) or other storage devices that are accessible by the device 700. The device 700 may load the program 730 from the computer-readable medium to the RAM 722 for execution. The computer-readable medium may include any types of tangible non-volatile storage, such as ROM, EPROM, a flash memory, a hard disk, CD, DVD, and the like.

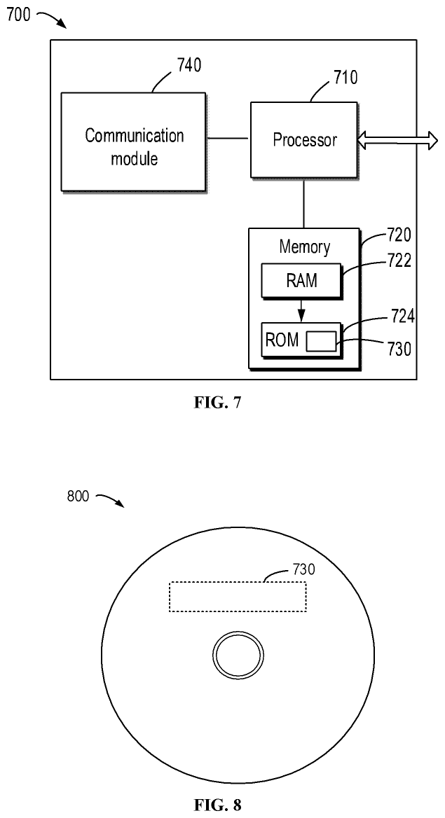

FIG. 8 illustrates a block diagram of an example of a computer-readable medium 1000 in accordance with some example embodiments of the present disclosure. The computer-readable medium 800 has the program 730 stored thereon. It is noted that although the computer-readable medium 800 is depicted in form of CD or DVD in FIG. 7, the computer-readable medium 800 may be in any other form suitable for carry or hold the program 730.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer-readable storage medium. The computer program product includes computer-executable instructions, such as those included in program modules, being executed in a device on a target real or virtual processor, to carry out the method 500 or 600 as described above with reference to FIG. 5 or 6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer-readable medium, and the like.

The computer-readable medium may be a computer-readable signal medium or a computer-readable storage medium. A computer-readable medium may include but not limited to an electronic, magnetic, optical, electromagnetic, infrared, or semiconductor system, apparatus, or device, or any suitable combination of the foregoing. More specific examples of the computer-readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

List of abbreviations

| | |
|---|---|
| LP-WUS | Low Power Wake-Up Signal |
| TAC | Timing Advance Command |
| MAC | Medium Access Control |
| TAT | Timing Alignment Timer |
| WuR | Wake-up Receiver |
| eDRX | extended Discontinuous Reception |
| IoT | Internet of Things |
| PDCCH | Physical Downlink Control CHannel |
| PDSCH | Physical Downlink Shared CHannel |
| PUCCH | Physical Uplink Control CHannel |
| PUSCH | Physical Uplink Shared CHannel |
| CSI | Channel State Information |
| SRS | Sounding Reference Signal |
| HARQ | Hybrid Automatic Repeat reQuest |
| AR | augmented reality |
| VR | virtual reality |
| XR | extended reality |

1.-35. (canceled)

36. An apparatus comprising:
at least one processor; and
at least one memory storing instructions that, when executed by the at least one processor, cause the apparatus at least to:
receive, from a network device, configuration information related to at least one of a channel-state information (CSI) report or a sounding reference signal (SRS) in a low power wake-up signal (LP-WUS) receiving mode of the apparatus; and
perform one of the following based on the configuration information:
transmitting, to the network device and while the apparatus is in the LP-WUS receiving mode, the at least one of the CSI report or the SRS; or
stopping transmission of the at least one of the CSI report or the SRS when the apparatus is in the LP-WUS receiving mode.

37. The apparatus of claim 36, wherein the apparatus is further caused to:
enter the LP-WUS receiving mode; and
monitor the LP-WUS during the LP-WUS receiving mode.

38. The apparatus of claim 36, wherein the apparatus is caused to perform the transmitting by:
based on the configuration information indicating that the at least one of the CSI report or the SRS is to be transmitted in the LP-WUS receiving mode, transmitting, to the network device, the at least one of the CSI report or the SRS while the apparatus is in the LP-WUS receiving mode.

39. The apparatus of claim 36, wherein the apparatus is caused to perform the stopping by:
based on the configuration information indicating that transmission of the at least one of the CSI report or the SRS is to be stopped in the LP-WUS receiving mode, stopping the transmission of the at least one of the CSI report or the SRS when the apparatus is in the LP-WUS receiving mode.

40. The apparatus of claim 36, wherein the configuration information comprises a timer for the transmission of the at least one of the CSI report or the SRS.

41. The apparatus of claim 40, wherein the apparatus is caused to stop the transmission by:
starting the timer when the apparatus starts to monitor the LP-WUS; and
stopping the transmission of the at least one of the CSI report or the SRS when the timer expires.

42. The apparatus of claim 36, wherein:
the configuration information indicates a first transmission configuration and a second transmission configuration different from the first transmission configuration;
the first transmission configuration is used for transmission of the at least one of the CSI report or the SRS when the apparatus is in a physical downlink control channel (PDCCH) monitoring mode; and
the second transmission configuration is used for the transmission of the at least one of the CSI report or the SRS when the apparatus is in the LP-WUS receiving mode.

43. The apparatus of claim 42, wherein the apparatus is further caused to:
based on receiving an LP-WUS from the network device, switch from the LP-WUS receiving mode to the PDCCH monitoring mode;
deactivate the second transmission configuration; and
activate the first transmission configuration.

44. The apparatus of claim 43, wherein the apparatus is configured with connected mode discontinuous reception (DRX), and the apparatus is further caused to:
prior to receiving the LP-WUS, enter LP-WUS receiving mode at beginning of an onDuration/Active timer.

45. The apparatus of claim 42, wherein at least one of the following:
the first transmission configuration comprises a first periodicity and the second transmission configuration comprises a second periodicity different from the first periodicity;
the at least one of the CSI report or the SRS is periodic or semi-persistent (SP); or
the first transmission configuration and the second transmission configuration are indicated by the network device from a set of transmission configurations.

46. The apparatus of claim 45, wherein the second periodicity is a multiple of the first periodicity.

47. The apparatus of claim 45, wherein an offset value is configured between a first transmission occasion of the at least one of the CSI report or the SRS in a period of the first periodicity and a second transmission occasion of the at least one of the CSI report or the SRS in a period of the second periodicity.

48. The apparatus of claim 36, wherein:
the configuration information indicates a first time alignment timer (TAT) and a second TAT;
the first TAT is used for a PDCCH monitoring mode of the apparatus; and
the second TAT is used for the LP-WUS receiving mode of the apparatus.

49. The apparatus of claim 48, wherein the apparatus is further caused to at least one of the following:
based on monitoring the LP-WUS, start the second TAT; or
based on receiving the TAC MAC CE, restart the first TAT and the second TAT.

50. The apparatus of claim 48, wherein an expiry time of the second TAT is shorter than an expiry time of the first TAT.

51. The apparatus of claim 36, wherein the apparatus is further caused to, based on determining that a TAT expires when the apparatus is in the LP-WUS receiving mode, perform at least one of the following:
storing a timing advance (TA) value;
suspending an uplink configuration; or
avoiding flushing a hybrid automatic repeat request (HARQ) buffer for a HARQ process.

52. The apparatus of claim 51, wherein the apparatus is further caused to:
after switching from the LP-WUS receiving mode to a PDCCH monitoring mode, receive a message from the network device after receiving the LP-WUS;
based on determining that the message comprises a TAC MAC CE, perform at least one of the following:
restarting the TAT based on the stored TA value;
restoring the uplink configuration; and
continuing the HARQ process.

53. The apparatus of claim 52, wherein the apparatus is further caused to:
based on determining that the message does not comprise the TAC MAC CE, perform at least one of the following:
releasing the uplink configuration;
clearing at least one of a downlink/uplink configured grant or a physical uplink shared channel (PUSCH) for SP-CSI; and
flushing the HARQ buffer for the HARQ process.

54. A method comprising:
receiving, at a terminal device and from a network device, configuration information related to at least one of a channel-state information (CSI) report or a sounding reference signal (SRS) in a low power wake-up signal (LP-WUS) receiving mode of the terminal device; and
performing one of the following based on the configuration information:
transmitting, by the terminal device, to the network device and while the terminal device is in the LP-WUS receiving mode, the at least one of the CSI report or the SRS, or
stopping, by the terminal device, transmission of the at least one of the CSI report or the SRS when the apparatus is in the LP-WUS receiving mode.

55. An apparatus comprising:
means for receiving, from a network device, configuration information related to at least one of a channel-state information (CSI) report or a sounding reference signal (SRS) in a low power wake-up signal (LP-WUS) receiving mode of the apparatus; and
means for performing one of the following based on the configuration information:
transmitting, to the network device and while the apparatus is in the LP-WUS receiving mode, the at least one of the CSI report or the SRS, or
stopping transmission of the at least one of the CSI report or the SRS when the apparatus is in the LP-WUS receiving mode.
